(19) United States
(12) Patent Application Publication
(10) Pub. No.: US 2021/0374795 A1
(43) Pub. Date: Dec. 2, 2021

(54) METHOD FOR ADVERTISEMENT-PUSHING IN OUTDOOR ADVERTISING BASED ON VISITOR FLOW, APPARATUS, ELECTRONIC DEVICE, AND STORAGE MEDIUM THEREOF

(71) Applicant: HON HAI PRECISION INDUSTRY CO., LTD., New Taipei (TW)

(72) Inventor: JUNG-YI LIN, New Taipei (TW)

(21) Appl. No.: 17/018,474

(22) Filed: Sep. 11, 2020

(30) Foreign Application Priority Data
Jun. 1, 2020 (CN) 202010485237.9

(51) Int. Cl. G06Q 30/02; G06K 9/00; G06T 7/73

(52) U.S. Cl. CPC G06Q 30/0246; G06Q 30/0261; G06Q 30/0271; G06K 9/00771; G06T 2207/30242; G06K 9/00335; G06T 7/74; G06K 2209/21; G06K 9/00369

(57) ABSTRACT

A method applied to outdoor advertising for displaying a particular advertisement or particular type based on visitor flow includes acquiring images in a predetermined time duration, identifying specified targets in the acquired images, and counting members of specified target as different target member flows. A category of advertising content is matched based on different target member flows for extracting a specified number of adverts in the matching category. The extracted adverts repeatedly scroll on the electronic device after a specified time internal. An apparatus, an electronic device, and a storage medium applying the method are also disclosed.

### FIELD

The subject matter herein generally relates to advertising.

### BACKGROUND

Research suggests that outdoor advertising at for example shopping mall in city is more effective compared to printed advertising and advertising on the internet. Outdoor advertising could be made more targeted if visitor flow and categories of visitors are recognized. Much current outdoor advertising is static, any analyzing process is related to adults, the number of babies and pets included in the visitors is largely ignored. This negates the purpose of precision and targeted marketing.

Thus, there is room for improvement in the art.

### BRIEF DESCRIPTION OF THE FIGURES

Implementations of the present disclosure will now be described, by way of example only, with reference to the attached figures.

FIG. 1 is a flowchart illustrating an embodiment of method for pushing certain advertisements based on visitor flow.

FIG. 2 is a detailed flowchart illustrating the block 11 of the method of FIG. 1.

FIG. 3 is a diagram illustrating an embodiment of a first window on an image.

FIG. 4 is a detailed flowchart illustrating the block 12 of the method of FIG. 1.

FIG. 5 is a diagram illustrating an embodiment of an apparatus for displaying certain advertisements based on visitor flow.

FIG. 6 is a diagram illustrating an embodiment of electronic device applying the method of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

The present disclosure provides a method for pushing certain advertisements based on flow and categories of visitors.

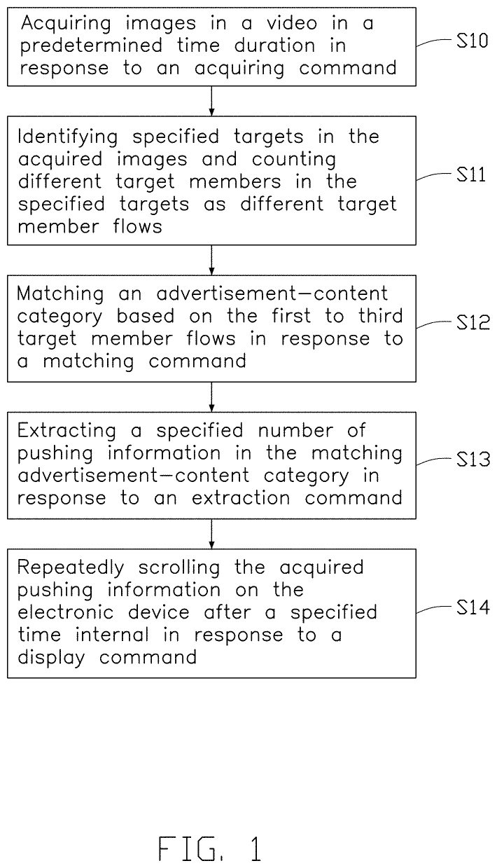

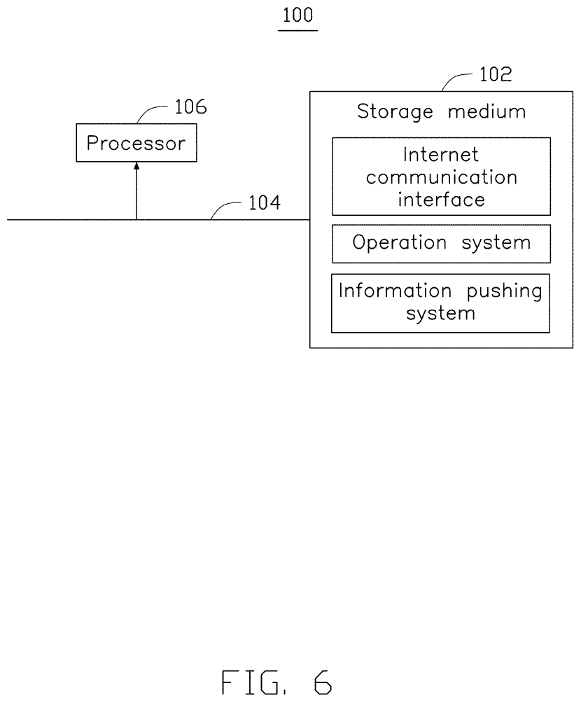

FIG. 1 shows a flowchart of a method for the above. The method is used in at least one electronic device 100 (as shown in FIG. 6) and at least one server. The electronic device 100 provides a visible interface for establishing a communication between users and the electronic device 100. Data between the electronic device 100 and the at least one server is transmitted by a specified protocol. In one embodiment, the specified protocol can be a Hyper Text Transfer Protocol (HTTP), or a Hyper Text Transfer Protocol over Secure Socket Layer (HTTPS), but not being limited hereto. In one embodiment, the server can be a single server, or can be a group of servers having different functions. The electronic device 100 can be a movable terminal with a networking function, such a personal computer, a tablet, a smart phone, a personal digital assistant (PDA), a game machine, an internet protocol television (IPTV), a smart wearable device, or a navigator. The electronic device 100 can be a fixed terminal with a networking function, such as an outdoor billboard, a desktop computer, or a digital television. In one embodiment, the electronic device 100 includes a storage medium 102 (as shown in FIG. 6). The storage medium 102 can store number of advertisements in different categories and an image identification model. The method acquires images in a video, identifies different advertising targets within a video, and counts the numbers of members within each target-group, all within a predetermined time duration. The content of advertisements within a certain category which is deemed to match the counted number within each target-group are repeatedly scrolled on at least one electronic device after a specified time internal. The method may comprise at least the following steps, which also may be re-ordered:

In block 10, images in a video are acquired in a predetermined time duration in response to an acquiring command.

In one embodiment, the images in the video are captured by a camera of the electronic device. The predetermined time duration can be a specified time duration in at least one day, and can be a specified time duration in at least one week, or in at least one month, in at least one quarter, or in at least one year. For example, the predetermined time duration can be a specified time duration from 7 a.m. to 10 a.m. in one week, or a specified time duration from 11 a.m. to 2 p.m. in two months. In at least one embodiment, the predetermined time duration can include number of different time durations, a time length of each time duration can be same or different. There is no overlapping between different time durations. For example, the predetermined time can include a time duration from 7 a.m. to 10 a.m., a time duration from 11 a.m. to 2 p.m., and a time duration from 5 p.m. to 9 p.m.

In block 11, specified targets in the acquired images are identified and different target members in the specified targets are counted as different target member flows.

In one embodiment, the specified target can be a person with a stroller for example. Each specified target can include first, second, and third target members. The first target member can be a person, the second target member can be a baby, and the third target member can be a cat or a dog as a pet.

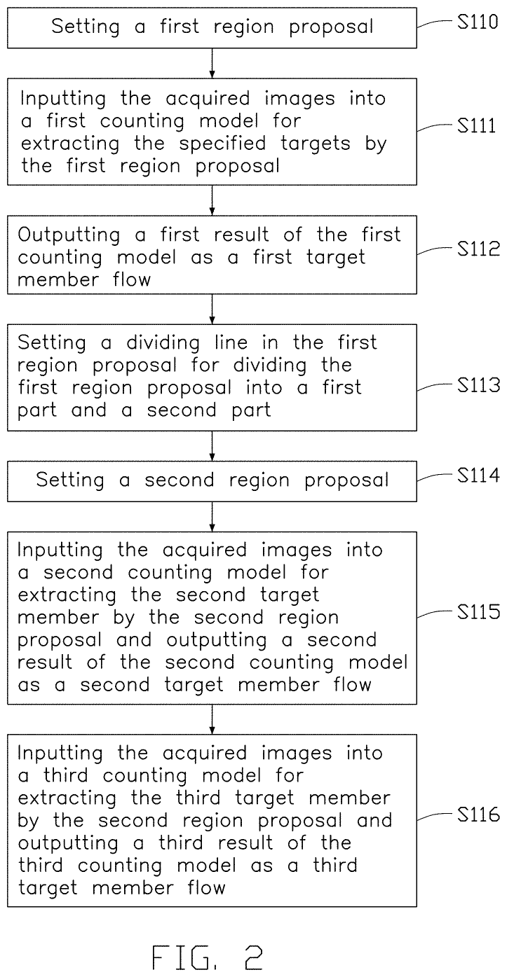

FIG. 2 shows a detail flowchart of the block 11. The block of the specified targets in the acquired images are identified and different target members in the specified targets are counted as different target member flows further comprising:

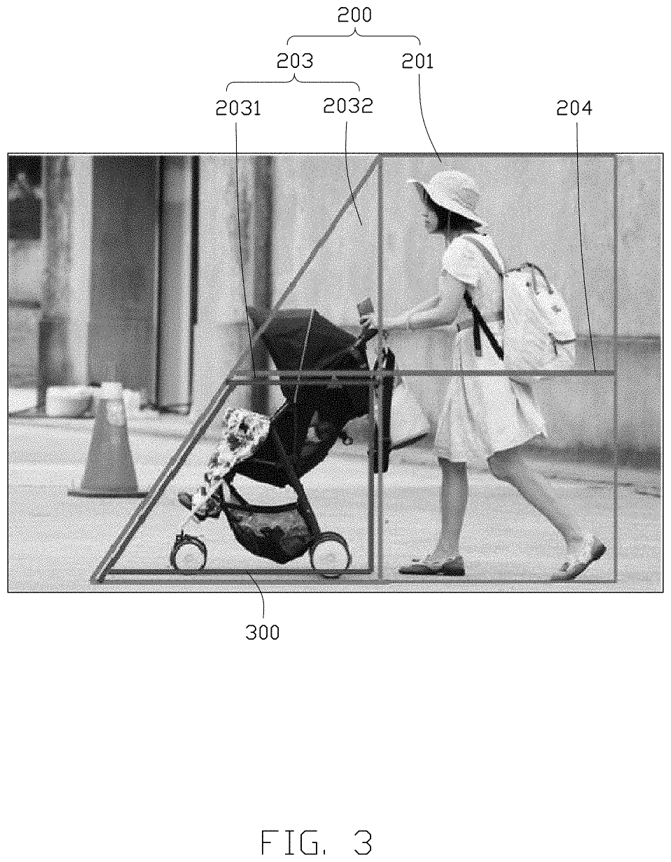

In block 110, a first region proposal 200 (as shown in FIG. 3) is set.

In block 111, the acquired images are inputted into a first counting model for extracting the specified targets by the first region proposal 200.

In block 112, the first result of the first counting model is output to serve as a first target member flow.

In block 113, a dividing line 204 (as shown in FIG. 3) is set in the first region proposal 200 for dividing the first region proposal 200 into a first part 201 (as shown in FIG. 3) and a second part 203 (as shown in FIG. 3).

In block 114, a second region proposal 2032 (as shown in FIG. 3) is set by an outline of the second part 203.

In block 115, the acquired images are inputted into a second counting model for executing the second target member by the second region proposal 2032, and the second result of the second counting model is output to serve as a second target member flow.

In block 116, the acquired images are inputted into a third counting model for executing the third target member by the second region proposal 2032, and the third result of the third counting model is output to serve as a third target member flow.

In one embodiment, the first counting model is a network model for detecting visitor flow, identifying the person with the stroller in the images, tracking, predicting, and counting. The second counting model is a network model for detecting and counting side face view in the stroller. The third counting model a network model for identifying and counting pets in the stroller. The first counting model, the second counting model, and the third counting model can be a same network model with all the functions, and also can be three separate network models. The first counting model, the second counting model, and the third counting model are combined with artificial intelligence (AI) model, face recognition model, and other deep learning model.

FIG. 3 shows an example of an acquired image divided into regions. In one embodiment, the first region proposal 200 is a substantially right-angled trapezoid shape. The region proposal 200 includes a first region 201 and a second region 203. The first region 201 is substantially a rectangle shape, and the second region 203 is a substantially triangle shape. The first region 201 is a box for identifying the person, the second region 203 is a box for identifying the stroller. The dividing line 204 is a median line which divides the second region 203 into the first part 2031 and the second part 2032. The second part 2032 serve as the second region proposal. The first part 2031 is substantially a triangle shape, and the second part 2032 is substantially a right-angled trapezoid shape.

In block 12, an advertisement-content category which is matching is determined, based on the first to third target member flows in response to a matching command.

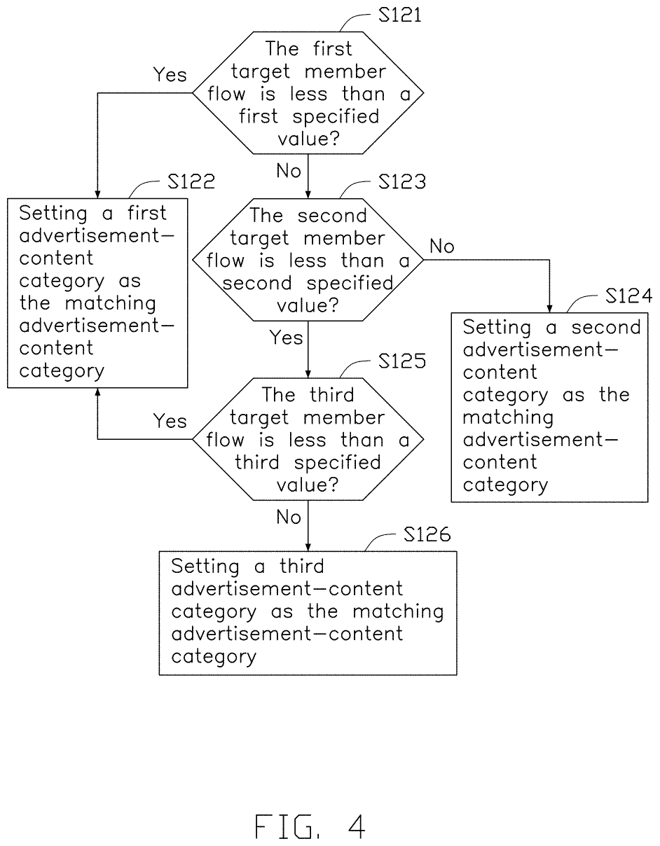

FIG. 4 shows a detailed flowchart of the block 12. In one embodiment, the block of the advertisement-content category which is matching is determined, based on the first to third target member flows in response to a matching command further comprising:

In block 121, whether the first target member flow is less than a first specified value.

In block 122, a first advertisement-content category is a matching advertisement-content category when the first target member flow is less than a first specified value.

In block 123, whether the second target member flow is less than a second specified value when the first target member flow is equal to or larger than a first specified value.

In block 124, a second advertisement-content category is a matching advertisement-content category when the second target member flow is equal to or larger than the second specified value.

In block 125, whether the third target member flow is less than a third specified value when the second target member flow is less than the second specified value.

In block 126, a third advertisement-content category is a matching advertisement-content category when the third target member flow is equal to or larger than the third specified value.

When the third target member flow is less than the third specified value, the procedure returns to block 122.

In one embodiment, the first advertisement-content category is a daily-life category, which can include clothes information, household appliances information, restaurant information, cinema information, and karaoke information. The second advertisement-content category is a mother-child category, which can include maternity shop information, child playground information, and after-school class information. The third advertisement-content category can be a pet category, which can include pet hospital information, a pet grooming information, and pet hotel information.

In block 13, a specified number of pushing information in the matching advertisement-content category are extracted in response to an extraction command.

In block 14, the pushing information so acquired are repeatedly scrolled on at least one electronic device after a specified time internal in response to a display command.

In one embodiment, all commands can be inputted by the terminal device. The terminal device can include a keyboard and a touch screen, not being limited. The commands can be inputted by operations on the visible interface. The operations can be sliding operations or click operations (such as a single click or double-click) on keys in the visible interface. In detail, the keys can be mechanical keys or virtual keys (such as virtual icons), but not limited hereto.

Based on the above method, different pushing information categories can be matched with the different target member flows in the image of the video, and the number of the pushing information in the matching advertisement-content category are acquired, thus marketing is made more precise and targeted.

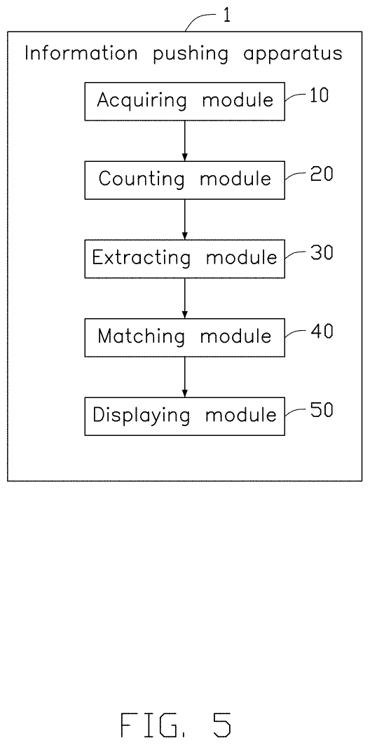

FIG. 5 shows an information pushing apparatus 1 based on a visitor flow. The information pushing apparatus 1 is used in an information pushing system with at least one electronic device and at least one server. Data between the electronic device and the at least one server is transmitted by a specified protocol. In one embodiment, the specified protocol can be a Hyper Text Transfer Protocol (HTTP), or a Hyper Text Transfer Protocol over Secure Socket Layer (HTTPS), but not being limited hereto. In one embodiment, the server can be a single server, or can be a group of servers having different functions.

In one embodiment, the information pushing apparatus 1 can include one or more modules. The one or more modules are stored in a storage medium 102 (as shown in FIG. 6) and can be implemented by at least one processor 106 (as shown in FIG. 6) for executing a route planning function.

In one embodiment, the information pushing apparatus 1 includes:

An acquiring module 10 acquires images in the video in a predetermined time duration in response to an acquiring command.

In one embodiment, the images in the video are captured by a camera of the electronic device. The predetermined time duration can be a specified time duration in at least one day, and can be a specified time duration in at least one week, or in at least one month, in at least one quarter, or in at least one year. For example, the predetermined time duration can be a specified time duration from 7 a.m. to 10 a.m. in one week, or a specified time duration from 11 a.m. to 2 p.m. in two months. In at least one embodiment, the predetermined time duration can include number of different time durations, a time length of each time duration can be same or different. There is no overlapping between different time durations. For example, the predetermined time can include a time duration from 7 a.m. to 10 a.m., a time duration from 11 a.m. to 2 p.m., and a time duration from 5 p.m. to 9 p.m.

A counting module 20 identifies specified targets in the acquired images and counts a number of members in each specified target as different target member flows.

In one embodiment, the specified target can be a person with a stroller. The specified target can include a first, second, and third target members. The first target member can be a person, the second target member can be baby, and the third target member can be a cat or a dog as a pet.

The counting module 20 further sets a first region proposal 200 (as shown in FIG. 3) and inputs the acquired images into a first counting model for extracting the specified targets by the first region proposal 200. The first result of the first counting model is output to serve as a first target member flow. The counting module 20 further sets a dividing line 204 (as shown in FIG. 3) in the first region proposal 200 for dividing the first region proposal 200 into a first part 201 (as shown in FIG. 3) and a second part 203 (as shown in FIG. 3). The counting module 20 further sets a second region proposal 2032 (as shown in FIG. 3) by an outline of the second part 203. The counting module 20 further inputs the acquired images into a second counting model for executing the second target member by the second region proposal 2032. The second result of the second counting model is output to serve as a second target member flow. The counting module 20 further inputs the acquired images into a third counting model for executing the third target member by the second region proposal 2032. The third result of the third counting model is output to serve as a third target member flow.

In one embodiment, the first counting model is a network model for detecting visitor flow, identifying the person with the stroller in the images, tracking, predicting, and counting. The second counting model is a network model for detecting and counting side face view in the stroller. The third counting model a network model for identifying and counting pet with the stroller. The first counting model, the second counting model, and the third counting model can be a same network model with all the functions, and can be three separate network model. The first counting model, the second counting model, and the third counting model are combined with artificial intelligence (AI) model, face recognition model, and other deep learning model.

FIG. 3 shows an example of the acquired image labeled the first region proposal 200, the driving line 204, and the second region proposal. In one embodiment, the first region proposal 200 is a substantially right-angled trapezoid shape. The region proposal 200 includes a first region 201 and a second region 203. The first region 201 is substantially a rectangle shape, and the second region 203 is a substantially triangle shape. The first region 201 is a box for identifying the person, the second region 203 is a box for identifying the stroller. The dividing line 204 is a median line which divides the second region 203 into the first part 2031 and the second part 2032. The second part 2032 serves as the second region proposal. The first part 2031 is substantially a triangle shape, and the second part 2032 is substantially a right-angled trapezoid shape.

A matching module 30 matches an advertisement-content category based on the first to third target member flows in response to a matching command.

The matching module 30 further determines whether the first target member flow is less than a first specified value. When the first target member flow is less than a first specified value, the matching module 30 determines that a first advertisement-content category as the matching advertisement-content category. The matching module 30 further determines whether the second target member flow is less than a second specified value when the first target member flow is equal to or larger than a first specified value. The matching module 30 further determines that a second advertisement-content category as the matching advertisement-content category when the second target member flow is equal to or larger than the second specified value. The matching module 30 further determines whether the third target member flow is less than a third specified value when the second target member flow is less than the second specified value. The matching module 30 further determines that a third advertisement-content category as the matching advertisement-content category when the third target member flow is equal to or larger than the third specified value.

In one embodiment, the first advertisement-content category is a daily-life category, which can include clothes information, household appliances information, restaurant information, cinema information, and karaoke information. The second advertisement-content category is a mother-child category, which can include maternity shop information, child playground information, and after-school class information. The third advertisement-content category can be a pet category, which can include pet hospital information, a pet grooming information, and pet hotel information.

An extracting module 40 extracts a specified number of pushing information in the matching advertisement-content category in response to an extraction command.

A display module 50 repeatedly scrolls the pushing information on at least one electronic device after a specified time internal in response to a display command.

In one embodiment, all commands can be inputted by the terminal device. The terminal device can include a keyboard and a touch screen, not being limited hereto. The commands can be inputted by operations on the visible interface. The operations can be sliding operations or click operations (such as a single click or double-click) on keys in the visible interface. In detail, the keys can be mechanical keys or virtual keys (such as virtual icons), but not limited hereto.

Based on the above method, different advertisement-content categories are ca be matched with the different target member flows in the image of the video, and the number of the pushing information in the matching advertisement-content category are acquired, thus the precision marketing is improved.

FIG. 6 shows an electronic device 100. The electronic device 100 includes at least one storage medium 102, a data bus 104, and at least one processor 106.

The at least one storage medium 102 stores program codes. The at least one storage medium 102 can be an embedded circuit having a storing function, such as memory card, trans-flash card, smart media card, secure digital card, and flash card, and so on. The at least one storage medium 102 transmits data with the at least one processor 106 through the data bus 104. The at least one storage medium 102 stores an operation system, an internet communication interface, and the information pushing program. The operation system manages and controls hardware and programs of software. The operation system further supports operations of other software and programs. The internet communication interface establishes communications between the members in the at least one storage medium 102, and communications between the hardware and the software in the electronic device 100.

The at least one processor 106 can be a micro-processor, or a digital processor. The at least one processor 106 is used for running the program codes stored in the at least one storage device 102 to execute different functions. The modules in FIG. 2 are program codes stored in the at least one storage medium 102 and are implemented by the at least one processor 106 for executing the method for route planning. The at least one processor 106 can be a central processing unit (CPU), or a large scale integrated circuit, being an operating core and a control core.

The at least one processor 106 executes commands stored in the at least one storage device 102 to perform the method. The commands executed by the processor 106 perform the following steps:

In block 10, images in a video are acquired in a predetermined time duration in response to an acquiring command.

In one embodiment, the images in the video is captured by a camera of the electronic device. The predetermined time duration can be a specified time duration in at least one day, and can be a specified time duration in at least one week, or in at least one month, in at least one quarter, or in at least one year. For example, the predetermined time duration can be a specified time duration from 7 a.m. to 10 a.m. in one week, or a specified time duration from 11 a.m. to 2 p.m. in two months. In at least one embodiment, the predetermined time duration can include number of different time durations, a time length of each time duration can be same or different. There is no overlapping between different time durations. For example, the predetermined time can include a time duration from 7 a.m. to 10 a.m., a time duration from 11 a.m. to 2 p.m., and a time duration from 5 p.m. to 9 p.m.

In block 11, specified targets in the acquired images are identified and different target members in the specified targets are counted as different target member flows.

In one embodiment, the specified target can be a person with a stroller. The specified target can include a first, second, and third target members. The first target member can be a person, the second target member can be baby, and the third target member can be a cat or a dog as a pet.

FIG. 2 shows a detail flowchart of the block 11. The block of the specified targets in the acquired images are identified and different target members in the specified targets are counted as different target member flow further comprises:

In block 110, a first region proposal 200 (as shown in FIG. 3) is set.

In block 111, the acquired images are inputted into a first counting model for extracting the specified targets by the first region proposal 200.

In block 112, the first result of the first counting model is output to serve as a first target member flow.

In block 113, a dividing line 204 (as shown in FIG. 3) is set in the first region proposal 200 for dividing the first region proposal 200 into a first part 201 (as shown in FIG. 3) and a second part 203 (as shown in FIG. 3).

In block 114, a second region proposal 2032 (as shown in FIG. 3) is set by an outline of the second part 203.

In block 115, the acquired images are inputted into a second counting model for executing the second target member by the second region proposal 2032, and the second result of the second counting model is output to serve as a second target member flow.

In block 116, the acquired images are inputted into a third counting model for executing the third target member by the second region proposal 2032, and the third result of the third counting model is output to serve as a third target member flow.

In one embodiment, the first counting model is a network model for detecting visitor flow, identifying the person with the stroller in the images, tracking, predicting, and counting. The second counting model is a network model for detecting and counting side face view in the stroller. The third counting model a network model for identifying and counting pets in the stroller. The first counting model, the second counting model, and the third counting model can be a same network model with all the functions, and can be three separate network model. The first counting model, the second counting model, and the third counting model are combined with artificial intelligence (AI) model, face recognition model, and other deep learning model.

FIG. 3 shows an example of an acquired image divided into regions. In one embodiment, the first region proposal 200 is a substantially right-angled trapezoid shape. The region proposal 200 includes a first region 201 and a second region 203. The first region 201 is substantially a rectangle shape, and the second region 203 is a substantially triangle shape. The first region 201 is a box for identifying the person, the second region 203 is a box for identifying the stroller. The dividing line 204 is a median line which divides the second region 203 into the first part 2031 and the second part 2032. The second part 2032 serves as the second region proposal. The first part 2031 is substantially a triangle shape, and the second part 2032 is substantially a right-angled trapezoid shape.

In block 12, an advertisement-content category which is matching is determined, based on the first to third target member flows in response to a matching command.

FIG. 4 shows a detailed flowchart of the block 12. In one embodiment, the block of the advertisement-content category which is matching is determined, based on the first to third target member flows in response to a matching command further comprises:

In block 121, whether the first target member flow is less than a first specified value.

In block 122, a first advertisement-content category is a matching advertisement-content category when the first target member flow is less than a first specified value.

In block 123, whether the second target member flow is less than a second specified value when the first target member flow is equal to or larger than a first specified value.

In block 124, a second advertisement-content category is a matching advertisement-content category when the second target member flow is equal to or larger than the second specified value.

In block 125, whether the third target member flow is less than a third specified value when the second target member flow is less than the second specified value.

In block 126, a third advertisement-content category is a matching advertisement-content category when the third target member flow is equal to or larger than the third specified value.

When the third target member flow is less than the third specified value, the procedure returns to block 122.

In one embodiment, the first advertisement-content category is a daily-life category, which can include clothes information, household appliances information, restaurant information, cinema information, and karaoke information. The second advertisement-content category is a mother-child category, which can include maternity shop information, child playground information, and after-school class information. The third advertisement-content category can be a pet category, which can include pet hospital information, a pet grooming information, and pet hotel information.

In block 13, a specified number of pushing information in the matching advertisement-content category are extracted in response to an extraction command.

In block 14, the acquired pushing information are repeatedly scrolled on at least one electronic device after a specified time internal in response to a display command.

Based on the above method, different advertisement-content categories are matched with the different target member flows in the image of the video, and the number of the pushing information in the matching advertisement-content category are acquired, thus marketing is made more precise and targeted.

While various and preferred embodiments have been described the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A method for pushing outdoor information on an electronic device based on visitor flow, the electronic device comprises a storage medium; the storage medium stores at least one command; the at least one command is implemented by a processor to execute:
acquiring images in a video in a predetermined time duration in response to an acquiring command;
identifying specified targets in the acquired images and counting different target members in the specified target as different target member flows;
matching an advertisement-content category based on the first to third target member flow in response to a matching command;
extracting a specified number of pushing information in the matching advertisement-content category in response to an extracting command; and
repeatedly scrolling the acquired pushing information on the electronic device after a specified time internal in response to a display command.

2. The method of claim 1, wherein the step of identifying specified targets in the acquired images and counting different target members in the specified target as different target member flows comprises:
setting a first region proposal;
inputting the acquired images into a first counting model for extracting the specified targets by the first region proposal;
outputting a first counting result of the first counting model as a first target member flow;
setting a dividing line in the first region proposal for dividing the first region proposal into a first part and a second part;
setting a second region proposal;
inputting the acquired images into a second counting model for extracting the second target member by the second region proposal and outputting a second counting result of the second counting model as a second target member flow; and
inputting the acquired images into a third counting model for extracting the third target member by the second region proposal and outputting a third counting result of the third counting model as a third target member flow.

3. The method of claim 2, wherein the first region proposal and the second region proposal are substantially right-angled trapezoid shaped.

4. The method of claim 2, wherein the dividing line is a median line of the first region proposal.

5. The method of claim 1, wherein the step of matching an advertisement-content category based on the first to third target member flows in response to a matching command comprises:
determining whether the first target member flow is less than a first specified value;
setting a first advertisement-content category as the matching advertisement-content category when the first target member flow is less than a first specified value;
determining whether the second target member flow is less than a second specified value when the first target member flow is equal to or larger than a first specified value;
setting a second advertisement-content category as the matching advertisement-content category when the second target member flow is equal to or larger than the second specified value;
determining whether the third target member flow is less than a third specified value when the second target member flow is less than the second specified value; and
setting a third advertisement-content category as the matched category when the third target member flow is equal to or larger than the third specified value.

6. An information pushing apparatus comprises a storage medium and at least one processor; the storage medium stores at least one command; the at least one commands is implemented by the at least one processor to execute functions; the storage medium comprising:
an acquiring module, configured to acquire images in a video in a predetermined time duration in response to an acquiring command;
a counting module, configured to identify specified targets in the acquired images, and count different target members in the specified target as different target member flows;
a matching module, configured to match an advertisement-content category based on the first to third target member flows in response to a matching command;
an extracting module, configured to extract a specified number of pushing information in the matching advertisement-content category in response to an extracting command; and
a display module, configured to repeatedly scroll the acquired pushing information on the electronic device after a specified time internal in response to a display command.

7. The information pushing apparatus of claim 6, wherein the counting module further sets a first region proposal, and inputs the acquired images into a first counting model for extracting the specified targets by the first region proposal; the first output result of the first counting model is served as a first target member flow; the counting module further sets a dividing line in the first region proposal for dividing the first region proposal into a first part and a second part; the counting module further sets a second region proposal by an outline of the second part; the counting module further inputs the acquired images into a second counting model for executing the second target member by the second region proposal; the second output result of the second counting model is served as a second target member flow; the counting module further inputs the acquired images into a third counting model for executing the third target member by the second region proposal; the third output result of the second counting model is served as a third target member flow.

8. The information pushing apparatus of claim 7, wherein the first region proposal and the second region proposal are substantially right-angled trapezoid shaped.

9. The information pushing apparatus of claim 7, wherein the dividing line is a median line of the first region proposal.

10. The information pushing apparatus of claim 6, wherein the matching module further determines whether the first target member flow is less than a first specified value; when the first target member flow is less than a first specified value, the matching module further determines that a first advertisement-content category as the matched category; when the first target member flow is equal to or larger than a first specified value, the matching module further determines whether the second target member flow is less than a second specified value; when the second target member flow is equal to or larger than the second specified value, the matching module further determines that a second advertisement-content category as the matched category; when the second target member flow is less than the second specified value, the matching module further determines whether the third target member flow is less than a third specified value; when the third target member flow is equal to or larger than the third specified value, the matching module further determines that a third advertisement-content category as the matching advertisement-content category.

11. An electronic device comprises a storage medium and at least one processor; the storage medium stores at least one command; the at least one commands is implemented by the at least one processor to execute functions; the storage medium comprising:
an acquiring module, configured to acquire images in a video in a predetermined time duration in response to an acquiring command;
a counting module, configured to identify specified targets in the acquired images, and count different target members in the specified target as different target member flows;
a matching module, configured to match an advertisement-content category based on the first to third target member flow in response to a matching command;
an extracting module, configured to extract a specified number of pushing information in the matching advertisement-content category in response to an extracting command; and
a display module, configured to repeatedly scroll the acquired pushing information on the electronic device after a specified time internal in response to a display command.

12. The electronic device of claim 11, wherein the counting module further sets a first region proposal, and inputs the acquired images into a first counting model for extracting the specified targets by the first region proposal; the first output result of the first counting model is served as a first target member flow; the counting module further sets a dividing line in the first region proposal for dividing the first region proposal into a first part and a second part; the counting module further sets a second region proposal by an outline of the second part; the counting module further inputs the acquired images into a second counting model for executing the second target member by the second region proposal; the second output result of the second counting model is served as a second target member flow; the counting module further inputs the acquired images into a third counting model for executing the third target member by the second region proposal; the third output result of the second counting model is served as a third target member flow.

13. The electronic device of claim 12, wherein the first region proposal and the second region proposal are substantially right-angled trapezoid shaped.

14. The electronic device of claim 12, wherein the dividing line is a median line of the first region proposal.

15. The electronic device of claim 11, wherein the matching module further determines whether the first target member flow is less than a first specified value; when the first target member flow is less than a first specified value, the matching module further determines that a first advertisement-content category as the matching advertisement-content category; when the first target member flow is equal to or larger than a first specified value, the matching module further determines whether the second target member flow is less than a second specified value; when the second target member flow is equal to or larger than the second specified value, the matching module further determines that a second advertisement-content category as the matching advertisement-content category; when the second target member flow is less than the second specified value, the matching module further determines whether the third target member flow is less than a third specified value; when the third target member flow is equal to or larger than the third specified value, the matching module further determines that a third advertisement-content category as the matching advertisement-content category.

16. A storage medium, the storage medium is a computer readable storage medium;
the storage medium stores at least one command; the at least one command is implemented by a processor to execute the following steps:
acquiring images in a video in a predetermined time duration in response to an acquiring command;
identifying specified targets in the acquired images and counting different target members in the specified target as different target member flows;
matching an advertisement-content category based on the first to third target member flow in response to a matching command;
extracting a specified number of pushing information in the matching advertisement-content category in response to an extracting command; and
repeatedly scrolling the acquired pushing information on the electronic device after a specified time internal in response to a display command.

17. The storage medium of claim 16, wherein the step of identifying specified targets in the acquired images and counting different target members in the specified target as different target member flows comprises:
setting a first region proposal;
inputting the acquired images into a first counting model for extracting the specified targets by the first region proposal;
outputting a first counting result of the first counting model as a first target member flow;
setting a dividing line in the first region proposal for dividing the first region proposal into a first part and a second part;
setting a second region proposal;
inputting the acquired images into a second counting model for extracting the second target member by the second region proposal and outputting a second counting result of the second counting model as a second target member flow; and
inputting the acquired images into a third counting model for extracting the third target member by the second region proposal and outputting a third counting result of the third counting model as a third target member flow.

18. The storage medium of claim 17, wherein the first region proposal and the second region proposal are substantially right-angled trapezoid shaped.

19. The storage medium of claim 17, wherein the dividing line is a median line of the first region proposal.

20. The storage medium of claim 16, wherein the step of matching an advertisement-content category based on the first to third target member flow in response to a matching command comprises:
determining whether the first target member flow is less than a first specified value;
setting a first advertisement-content category as the matching advertisement-content category when the first target member flow is less than a first specified value;
determining whether the second target member flow is less than a second specified value when the first target member flow is equal to or larger than a first specified value;
setting a second advertisement-content category as the matching advertisement-content category when the second target member flow is equal to or larger than the second specified value;
determining whether the third target member flow is less than a third specified value when the second target member flow is less than the second specified value; and
setting a third advertisement-content category as the matching advertisement-content category when the third target member flow is equal to or larger than the third specified value.
